(19) United States
(12) Patent Application Publication
(10) Pub. No.: US 2004/0144473 A1
(43) Pub. Date: Jul. 29, 2004

(54) Structure forming method and apparatus

(76) Inventor: Leroy Payne, Billings, MT (US)

Correspondence Address: Arthur L Urban, HC 50 Box 4045, Red Lodge, MT, 59068-9708, US

(21) Appl. No.: 10/475,864

(22) PCT Filed: Feb. 4, 2002
(86) PCT No.: PCT/US02/02916

(51) Int. Cl. B32B 31/12; B29C 70/86

(52) U.S. Cl. 156/64; 156/92; 156/265; 156/307.3; 156/361; 156/378; 156/547; 156/543; 156/578

(57) ABSTRACT

A method of forming a continuous composite structure includes the steps of predetermining relative proportions of a liquid resin forming material, a catalyst, and a inhibitor from respective reservoir (32, 33, 34) based on the ambient temperature and a porous blanket. The predetermined proportions are recirculated independently substantially continuously and coordinated at preselected rates. The predetermined proportions are simultaneously withdrawn and continuously mixed in a chamber (39) having a dispensing outlet (40). A pool (46) of the mixture is formed on the blanket (44) and a leading edge (68) is advanced substantially immediately into permanent contact with a preselected final surface and adhered thereto. Part of the catalyzed and inhibited resin forming material migrates through the blanket to form a continuous resin matrix therein.

This application is a continuation-in-part of pending International application No. PCT/US01/25740, filed Apr. 26, 2001, which in turn is a continuation-in-part of pending International application No. PCT/US00/19248, filed Jul. 13, 2000, which in turn is a continuation-in-part of pending International application No. PCT/US99/21675, filed Sep. 20, 1999, which in turn is a continuation-in-part of pending International application No. PCT/US98/23034, filed Oct. 30, 1998, which in turn is a continuation-in-part of pending International application No. PCT/US96/15499, filed Sep. 26, 1996, which in turn is a continuation-in-part of pending International application No. PCT/US96/05132, filed May 20, 1996, now U.S. Pat. No. 6,139,663, which in turn is a continuation-in-part of International application No. PCT/US95/05450, filed May 4, 1995, now U.S. Pat. No. 5,725,716, which in turn is a continuation-in-part of U.S. application Ser. No. 239,540, filed May 9, 1994, now U.S. Pat. No. 5,496,434, which in turn is a continuation-in-part of U.S. application Ser. No. 870,927, filed Apr. 20, 1992, now U.S. Pat. No. 5,330,603, which in turn is a continuation-in-part of U.S. application Ser. No. 753,344, filed Aug. 30, 1991, now U.S. Pat. No. 5,145,282, which in turn is a continuation-in-part of U.S. application Ser. No. 521,442, filed May 10, 1990, now U.S. Pat. No. 5,049,006, which in turn is a continuation-in-part of U.S. application Ser. No. 417,501, filed Oct. 5, 1989, now U.S. Pat. No. 4,955,760, which in turn is a continuation-in-part of U.S. application Ser. No. 235,205, filed Aug. 23, 1988, now U.S. Pat. No. 4,872,784.

This invention relates to a novel continuous structure forming method and apparatus. The present invention provides a novel method and apparatus which overcome the shortcomings of previous expedients. In addition, the method and apparatus provide features and advantages not found in earlier technology. The method and apparatus of the invention can be modified to form a variety of structures of high quality.

A novel method of the present invention for forming a substantially continuous composite structure includes the steps of preselecting a liquid reactive resin forming material, a catalyst, an inhibitor and a porous blanket. The ambient temperature is measured and the relative proportions of the resin forming material, the catalyst and the inhibitor are determined based on the ambient temperature and the porous blanket.

A mixture of the above components is formed by recirculating independently the predetermined proportions of the resin forming material, the catalyst and the inhibitor substantially continuously while coordinating the independent recirculation at preselected rates. Simultaneously, the predetermined proportion of each component is withdrawn from the independently recirculating resin forming material, catalyst and inhibitor and the withdrawn components mixed substantially continuously.

A pool of the mixture is formed on the blanket while it is moving over an elongated arcuate surface disposed in a preselected orientation closely adjacent to a preselected final location. A leading edge of the mixture-treated blanket is advanced substantially immediately into permanent contact with a preselected final surface. The leading edge is adhered to the final surface.

The apparatus is withdrawn and a moving mixture-treated blanket is deposited along a preselected path of the final surface. The moving blanket is adhered to the final surface while migrating part of the catalyzed and inhibited resin forming material through the blanket substantially uniformly to form a continuous resin matrix within the blanket. A tight permanent bond is formed between the matrix/blanket and the final surface.

Advantageously, pressure is applied to the treated blanket to form the permanent bond. A preselected tension is created in the blanket as it is advanced into contact with the final surface and adhered thereto. Spaced hook elements may be positioned in a preselected pattern over the final surface prior to contacting the blanket therewith.

The mixture-treated blanket preferably is cut into predetermined lengths and a plurality of the treated blanket lengths arranged successively in a preselected overlapping relationship to form a continuous structural assembly of considerable length.

Benefits and advantages of the novel method and apparatus of the present invention will be apparent from the following description of the accompanying drawings in which:

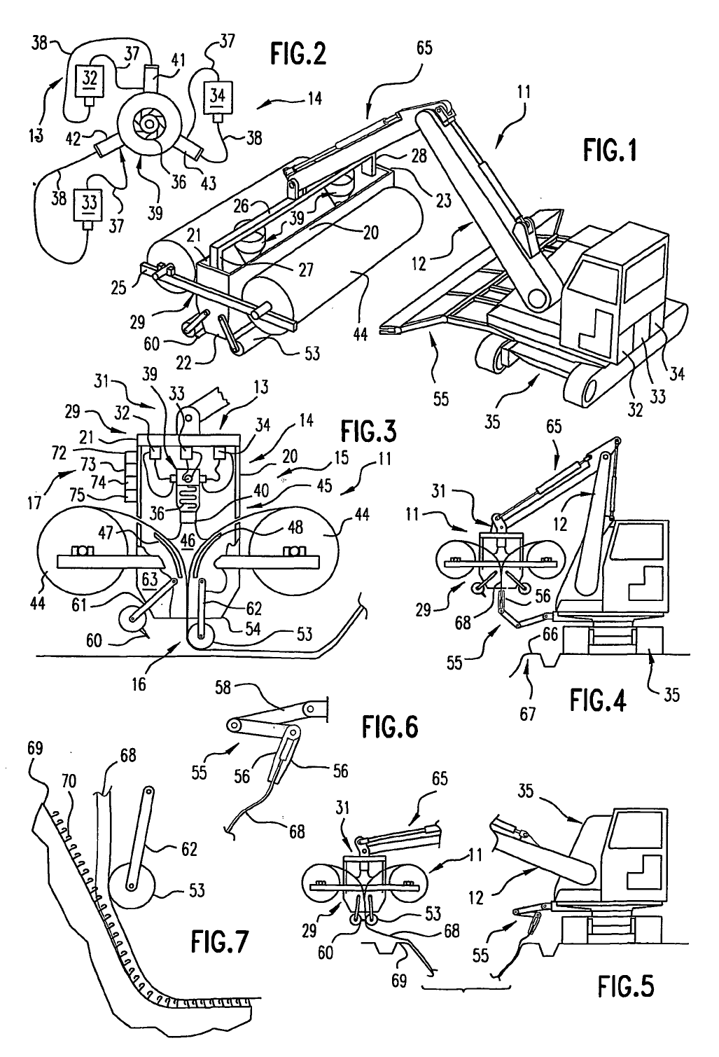

FIG. 1 is a view in perspective of one form of continuous structure forming apparatus of the present invention;

FIG. 2 is an enlarged fragmentary top view of the mixing portion of the structure forming apparatus of the invention shown in FIG. 1;

FIG. 3 is an enlarged fragmentary side view of the structure forming apparatus of the invention shown in FIG. 1;

FIG. 4 is a schematic illustration of the structure forming apparatus of the invention shown in FIG. 1 in use;

FIG. 5 is a schematic illustration of the structure forming apparatus of the invention shown in FIG. 4 at a later stage of use;

FIG. 6 is an enlarged schematic illustration of the grasping portion of the structure forming apparatus of the invention; and

FIG. 7 is a fragmentary alternate form of the structure forming apparatus of the invention.

As shown in the drawings, one form of novel continuous structure forming apparatus 11 of the present invention includes a supporting portion 12, a material supplying portion 13, a mixing portion 14, a matrix forming portion 15, a positioning portion 16 and a control portion 17.

The supporting portion 12 of the structure forming apparatus of the invention includes a plurality of spaced upstanding frame members 20,21,22,23. A plurality of frame members 25,26,27,28 join, the frame members 20-23 to provide a frame assembly 29.

The supporting portion 12 advantageously includes connector means 31 as well as accessories such as electrical generators, air compressors, hydraulic pumps, etc. (not shown). Such accessories can be mounted on and/or suspended from the frame members.

The material supplying portion 13 of the apparatus 11 includes a plurality of reservoirs 32,33,34 operatively connected with the supporting portion 12. The reservoirs which advantageously are located on a separate vehicle 35 are connected independently with the mixing portion 14, preferably through conduit means 37,38.

The mixing portion 14 of the structure forming apparatus 11 of the invention includes one or more elongated mixing chambers 39 adjustably disposed on the supporting portion 12. Each delivery conduit 37 is connected with a valve assembly 41,42,43 arranged around the periphery of a mixing chamber 39. A recirculating conduit 38 extends between each valve assembly 41,42,43 back to each respective reservoir 32,33,34.

The matrix forming portion 15 of the apparatus 11 includes mixture distributing means 45 adjacent an outlet 40 of the mixing chamber 39 and adjustable downwardly therefrom. The mixture distributing means 45 as shown in the drawings includes a pair of spaced elongated transversely disposed arcuate members 47,48 with generally horizontal lower edges adjustably oriented closer together than upper edges thereof.

The matrix forming portion 15 also may include second mixture distributing means (not shown) adjacent the first mixture distributing means 45. The second mixture distributing means may include a plurality of spaced spray nozzles or other distributing means.

The positioning portion 16 of the structure forming apparatus of the invention includes pressure applying means such as pivotable pressure roller 53 which is extendable beyond an edge 54 of the apparatus.

Advantageously, the positioning portion 16 includes elongated structure grasping means 55 mounted on vehicle 35. The structure grasping means preferably is mounted along the side of the vehicle adjacent to the apparatus 11. The grasping means 55 most preferably includes cooperating hinge sections 56 extending from pivotable link members 58. The operation of the grasping means is coordinated with the operation of the apparatus 11.

A cutter blade 60 advantageously is disposed on a pivoting arm member 61. The blade preferably is engageable with a roller such as pressure roller 53 disposed on an adjacent pivoting arm member 62.

The apparatus 11 may include removable outer panels 63 selectively hung from the apparatus to enclose the apparatus during storage. Also, the panels help to control wind, temperature, other weather conditions, etc. during operation.

In the formation of a substantially continuous composite structure with the apparatus 11 of the invention as shown in the drawings, the structure forming apparatus is suspended from a cantilever extendable arm assembly 65 extending from a 360 degree rotatable turntable on a vehicle 35 such as a tractor, truck, trailer or the like. The machinery is transferred to a job site and positioned adjacent to a previously selected starting position.

Operation of the structure forming apparatus 11 is begun by preselecting a liquid reactive resin forming material, a catalyst, an inhibitor and a porous blanket. The ambient temperature is measured. With this information, the relative proportions of the resin forming material, catalyst and inhibitor are determined based on the ambient temperature and the construction of the porous blanket.

The liquid reactive resin forming material is recirculated continuously from a reservoir 32 through a delivery conduit 37 into valve assembly 41 adjacent mixing chamber 39 and back through return conduit 38 to its reservoir. In the same way, catalyst and inhibitor each in a separate reservoir 33,34 respectively, is independently recirculated through separate delivery conduits 37 into respective valve assemblies 42,43 and back through return conduits 38, each to its own reservoir 33 or 34. The recirculation of the components is coordinated at preselected rates.

The predetermined proportions are withdrawn from the independently recirculating resin forming material, catalyst and inhibitor by activating valve assemblies 41,42,43 simultaneously. The withdrawn predetermined proportions are continually mixed in chamber 39 by driven impeller 36.

The mixture delivered from outlet 40 of the mixing chamber 39 passes downwardly between elongated arcuate members 47,48 into contact with a porous blanket or blankets 44 moving therethrough. The mixture is delivered at a rate sufficient to form a residual pool 46 between the arcuate members.

As the leading edge 68 of blanket 44 exits the liquid pool with the arcuate members closely adjacent to the preselected final location, the leading edge is grasped by cooperating hinge sections 56 as shown in FIG. 4 and advanced substantially immediately into permanent contact with a preselected edge 66 of ditch 67 and adhered thereto.

With the leading edge 68 in permanent contact with the ditch edge, the apparatus 11 including the arcuate surfaces which is suspended from the cantilever arm assembly 65 of vehicle 35 is withdrawn and the blanket being delivered therefrom is deposited along a preselected path across the ditch surface while migrating part of the catalyzed and inhibited resin forming material through the blanket substantially uniformly to form a continuous resin matrix within the blanket. A tight permanent bond between the matrix/blanket and the final surface is created.

Uniform tension is maintained by adjusting the relative speed of the apparatus across the ditch surface. During this interval, roller 53 applies pressure to tightly bond the structure to the ditch surface 69. Blade 60 then is pivoted against roller 53 to cut the blanket into a preselected length (FIG. 5).

Thereafter, the apparatus 11 can be moved to a position adjacent to and slightly overlapping the blanket deposited previously. The steps of the method are repeated to deposit additional lengths of the structure individually in an overlapping relationship with the previous structure length and thereby form a continuous structural assembly of considerable length. Since each length is maintained under tension until installed into the ditch, the structural liner produced is uniform and smooth without folds or other imperfections.

FIG. 7 illustrates the use of spaced hook elements 70 to assist in holding the blanket 44 in place as it is permanently bonded tothe final surface.

To produce high quality continuous composite structures of the invention, it is important that all of the steps of the method be carefully coordinated by control portion 17. The control portion 17 of the structure forming apparatus 11 of the invention includes programmable memory means 72 and actuating means 73 responsive thereto in combination with coordinating means 74 to control the operation of the various components of apparatus 11. Preferably, the coordinating means includes a process controller 75 that initiates changes in the flows of materials and speeds of drives to bring variations therein back to the rates specified in the programs present in the memory 72. Advantageously, the control portion may control the lateral position of the blanket 44 with respect to a preselected path.

This coordination commonly is achieved through the transmission of information such as digital pulses from monitors and/or sensors at the control components to the process controller 75. The operating information is compared with the preselected programming parameters stored in the memory 72. If differences are detected, instructions from the controller 73 change the operation of the components to restore the various operations to the preselected processing specifications.

The reactive resin forming material employed to produce composite structures of the invention is selected to be capable of reaction to form the particular resin matrix or coating desired in the final structure. Advantageously, the material forms a thermosetting resin such as a polyurethane or polyester.

Should a polyurethane be desired, one reservoir may contain an isocyanate and another reservoir may contain a polyol. More commonly, the reservoirs may contain different partially formed materials which upon mixing interact to form the desired polyurethane. Examples of such partially formed materials include so-called “A stage” resins and “B stage” resins.

Other resin forming systems may utilize a single resin forming material in one reservoir and a catalyst and an inhibitor, each in other reservoirs. Additional components can be premixed with one of the resin formers, e.g. fillers, reinforcements, colors and the like.

A particulate solid additive material may be mixed with the liquid reactive resin forming material, preferably, in a proportion significantly greater than that of the resin forming material. The additive particles may be any of a wide variety of inexpensive materials readily available at a particular job site. Natural mineral particulate materials such as sand and gravel normally are available or can be produced simply by crushing rock at the site.

Also, materials such as waste or recycled materials which can be shredded or ground into particles of suitable size can be utilized. Especially useful are particles formed by shredding or grinding discarded tires. Since the particles are encapsulated with resin forming material and not saturated therewith, many different waste materials may be employed.

Suitable porous blankets include woven, knit, non-woven structures, etc. The blankets e.g. fabrics, mats, etc. may be formed of continuous or discontinuous fibers, yarns, slit ribbons and similar natural and synthetic fibrous materials. Reinforcing members such as ropes, cables, etc. extending longitudinally and/or transversely of the blanket centerline may be included if desired.

The above description and the accompanying drawings show that the present invention provides a novel method and apparatus which overcome the shortcomings of previous expedients and in addition, provide features and advantages not found in earlier technology. The method and apparatus can be modified to form a variety of different structures of high quality.

It will be apparent that various modifications can be made in the particular method and apparatus described in detail above and shown in the drawings within the scope of the present invention. Components and procedures employed can be changed to meet specific process and structural requirements.

These and other changes can be made in the method and apparatus of the invention provided the functioning and operation thereof are not adversely affected. Therefore, the scope of the present invention is to be limited only by the following claims.

1. A method of forming a continuous composite structure including the steps of preselecting a liquid reactive resin forming material, a catalyst, an inhibitor and a porous blanket, measuring ambient temperature, determining relative proportions of said resin forming material, said catalyst and said inhibitor based on said ambient temperature and said porous blanket, recirculating independently said predetermined proportions of said resin forming material, said catalyst and said inhibitor substantially continuously, coordinating said independent recirculation of said resin forming material, said catalyst and said inhibitor at preselected rates, simultaneously withdrawing said predetermined proportions from said independently recirculating resin forming material, catalyst and inhibitor, continuously mixing said withdrawn predetermined proportions, forming a pool of said mixture on said blanket while it is moving over an elongated arcuate surface disposed in a preselected orientation closely adjacent to a preselected final location, advancing a leading edge of said mixture-treated blanket substantially immediately into permanent contact with a preselected final surface, adhering said leading edge to said final surface, withdrawing said arcuate surface from said leading edge, depositing a moving blanket along a preselected path of said final surface, adhering said moving blanket to said final surface while migrating part of said catalyzed and inhibited resin forming material through said blanket substantially uniformly to form a continuous resin matrix within said blanket and forming a tight permanent bond between said matrix/blanket and said final surface.

2. A method of forming a continuous composite structure according to claim 1 including the step of applying pressure to said treated blanket while it is in contact with said final surface to form a tight permanent bond therebetween.

3. A method of forming a continuous composite structure according to claim 1 including the step of cutting said mixture-treated blanket into a predetermined length as it is advanced into contact with said final surface.

4. A method of forming a continuous composite structure according to claim 1 including the step of creating a preselected tension in said blanket before adhering said blanket to said final surface.

5. A method of forming a continuous composite structure according to claim 1 including the steps of successively repeating the steps of claim 1 and arranging a plurality of matrix/blanket lengths in an overlapping relationship to form a continuous structural assembly of considerable length.

6. A method of forming a continuous composite structure according to claim 5 including the step of arranging each successive matrix/blanket length with a preselected degree of overlap.

7. A method of forming a continuous composite structure according to claim 1 including the step of positioning a plurality of spaced hook elements in a preselected pattern over a final surface prior to advancing a leading edge of said mixture-treated blanket into permanent contact with said final surface.

8. A method of forming a continuous composite structure according to claim 1 including the step of moving said blanket through a pool of said mixture formed between spaced elongated arcuate surfaces oriented closely adjacent to said preselected final location.

9. A method of forming a continuous composite structure according to claim 1 including the step of spraying a liquid resin forming material onto a surface of said matrix/blanket while adhering it to said final surface.

10. Continuous structure forming apparatus including a supporting portion, a material supplying portion, a mixing portion, a matrix forming portion, a positioning portion and a control portion; said supporting portion including a plurality of spaced upstanding frame members, a plurality of generally horizontally disposed frame members joining said upstanding frame members, said supporting portion including connector means adjustably suspending said apparatus closely spaced a precise distance above a preselected final location; said material supplying portion including a plurality of reservoirs operatively associated with said supporting portion, said reservoirs being connected independently with said mixing portion, recirculating means disposed along each independent connecting means, valve means disposed along each independent connecting means adjacent said mixing portion, said valve means being interconnected to provide coordinated operation thereof; said mixing portion including an elongated mixing chamber adjustably disposed adjacent said supporting portion, a driven mixing element disposed axially within said elongated mixing chamber; said matrix forming portion including mixture distributing means extending adjustably downwardly from said mixing chamber and being disposed adjacent an outlet thereof, said mixture distributing means including at least one elongated arcuate member disposed in a generally horizontal orientaion; said positioning portion including pressure applying means disposed closely adjacent to said mixture distributing means; said control portion including programmable memory means, coordinating means, sensing means, actuating means, and circuitry transmitting signals from said sensing means to said coordinating means for comparison with said memory means and activation of said actuating means to form and place a continuous structure into a preselected final configuration while it is flexible and adhesive.

11. Continuous structure forming apparatus according to claim 10 wherein said pressure applying means includes an elongated roller.

12. Continuous structure forming apparatus according to claim 10 wherein said connector means is connectable to an extendable cantilever support arm assembly.

13. Continuous structure forming apparatus according to claim 10 wherein said supporting portion includes support members for spare blanket rolls adjacent said material supplying portion to facilitate substantially continuous operation of said apparatus.

14. Continuous structure forming apparatus according to claim 10 wherein said mixture distributing means includes a plurality of spaced spray nozzles.

15. Continuous structure forming apparatus according to claim 10 wherein said control portion includes means controlling the lateral position of said apparatus with respect to a preselected path.

16. Continuous structure forming apparatus according to claim 10 including means to accommodate the processing of different width structures.

17. Continuous structure forming apparatus according to claim 10 wherein said supporting portion includes removable outer panels.

18. Continuous structure forming apparatus according to claim 10 including separable drive means and supply means.

19. Continuous structure forming apparatus according to claim 18 wherein said drive means includes a 360 degree pivotable and endable cantilever support frame section.

20. Continuous structure forming apparatus according to claim 18 wherein said separable drive means includes a vehicle.
